(19) United States
(12) Patent Application Publication
(10) Pub. No.: US 2022/0156472 A1
(43) Pub. Date: May 19, 2022

(54) HUB FOR MANAGEMENT OF WIRELESS TAGS VIA A CLIENT DEVICE COUPLED TO THE HUB

(71) Applicant: OraTag, LLC, Greenwood Village, CO (US)

(72) Inventors: Alan Jacobs, Greenwood Village, CO (US); Jennifer Jacobs, Greenwood Village, CO (US); Prashant Mandawdhare, San Diego, CA (US)

(21) Appl. No.: 16/950,864

(22) Filed: Nov. 17, 2020

(51) Int. Cl. G06K 7/10; G06K 19/07; G06Q 50/28; H04L 29/06; H04L 29/08; G01D 7/00

(52) U.S. Cl. CPC G06K 7/10297; G06K 19/0723; G06Q 50/28; H04W 4/029; H04L 67/141; G01D 7/00; G06K 2007/10504; H04L 67/42

(57) ABSTRACT

A tracking system includes a hub coupled to a client device, such as a computer or mobile phone, and one or more tags configured to wirelessly communicate with the hub. The hub includes a web server and a radio frequency transceiver. A browser executing on the client device exchanges data with the web server included in the hub, allowing location of the one or more tags via the client device without installation of a dedicated application on the client device for communicating with the hub or with the one or more tags. Additionally, the client device may communicate with a remote server via a network to communicate with additional tags via the browser executing on the client device. The hub transmits an activation request to the one or more tags via near field communication, radio frequency communication, or another suitable wireless communication method.

### BACKGROUND

Inventory management systems allow users or businesses to track products and to evaluate fulfillment of orders with products. Many inventory management systems couple tags configured to emit radio frequency signals to products and include one or more devices that receive the radio frequency signals from the tags. A tag may be configured to include information identifying one or more products to which the tag in a radio frequency signal emitted by the tag is coupled and may also include location information for the tag in the radio frequency signal emitted by the tag.

However, in conventional inventory management systems, one or more specialized applications are installed on a client device to allow the client device to exchange data with tags. For example, a reader or a writer is coupled to a client device to read or to write data to a tag, and the client device is unable to communicate with the reader or with the writer unless a specific application for communicating with the reader or with the writer is installed on the client device. This use of a specific application for communicating with the reader or the writer limits the number of client devices capable of exchanging data with tags and increases complexity of managing client devices in an inventory management system by increasing a number of applications for client devices to execute and to maintain. Installation and maintenance of a specific application on client devices to exchange data with tags identifying products increases complexity of scaling an inventory management to include more client devices that exchange data with tags.

### SUMMARY

A tracking system includes a hub coupled to a client device, and one or more tags configured to wirelessly communicate with the hub. In various embodiments the client device comprises a laptop computer, a tablet computer, a mobile communication device, or any other suitable communication device. The hub includes a web server and a radio frequency transceiver. A browser application executing on the client device exchanges data with the web server included in the hub, allowing configuration of the one or more tags via the client device without installation of a dedicated application on the client device for communicating with the hub or with the one or more tags. The web server included in the hub serves content, such as web pages, to the client device via a connection between the hub and the client device, and a user provides information for communication to a tag to one or more web pages via the browser application. Through the connection between the client device and the hub, the browser application on the client device transmits the information received via the one or more web pages to the hub. The radio frequency transceiver of the hub transmits the information that the hub receives from the client device to a tag via near field communication, radio frequency communication, or another suitable wireless communication method. Similarly, the radio frequency transceiver of the hub may obtain data from a tag that the hub communicates to the browser application of the client device via one or more web pages served by the web server of the hub. Using the browser application executing on the client device to exchange data between the client device and the hub allows the client device and the hub to communicate without installing a specific application for communicating with the hub on the client devices. This simplifies communication of data between the client device and the hub, allowing additional client devices to exchange data with tags via the hubs by coupling the additional client devices to the hub and using browser applications executing on the additional client devices.

Additionally, the client device may communicate with an online system via a network to communicate with additional tags via the browser executing on the client device. For example, the online system receives information from the client device and communicates the information to one or more hubs in different locations, allowing the client device to transmit data to or to receive data from tags in varying locations. Further, the hub may establish a connection with the online system via the network, allowing the hub to exchange data with the online system. To exchange data with the online system, the web server included in the hub initially requests a connection to the online system via the network, and the online system establishes a connection with the hub in response to receiving the request. By initiating the connection to the online system, the hub may establish bidirectional communication with the online system. or with other third-party systems, via the network.

### BRIEF DESCRIPTION OF THE DRAWINGS

FIG. 1 is a block diagram of a system environment in which a hub coupled to a client device communicates with one or more tags, in accordance with an embodiment.

FIG. 2 is a block diagram of a hub configured to communicate with one or more tags, in accordance with an embodiment.

FIG. 3 is an interaction diagram of a client device communicating with one or more tags via a hub coupled to the client device, in accordance with an embodiment.

FIG. 4 is a is a process flow diagram of one embodiment of a client device communicating with a tag via a hub coupled to the client device, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

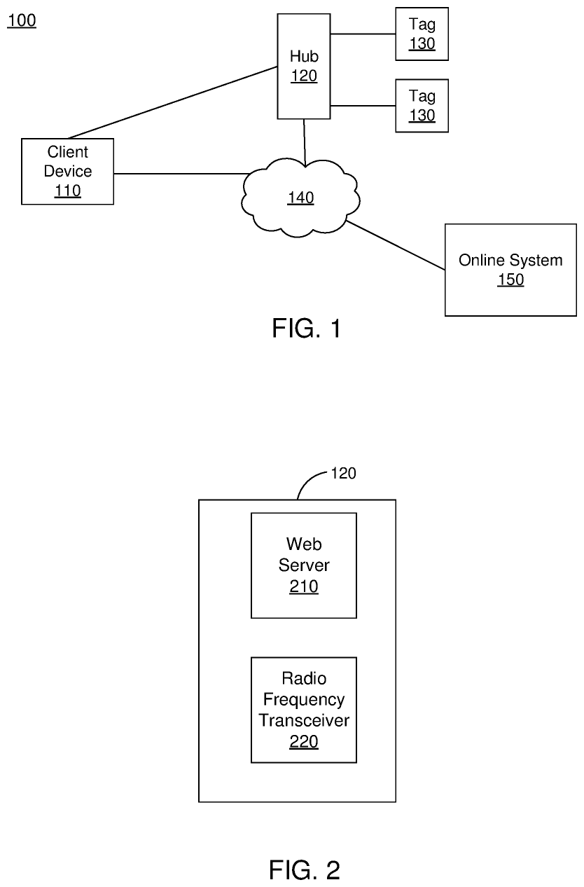

FIG. 1 is a block diagram of a system environment 100 in which a hub 120 communicates with one or more tags 130. The system environment 100 shown by FIG. 1 comprises a client device 110, the hub 120, one or more tags 130, a network 140, and an online system 150. In alternative configurations, different and/or additional components may be included in the system environment 100. For example, one or more third-party systems are also coupled to the network 140.

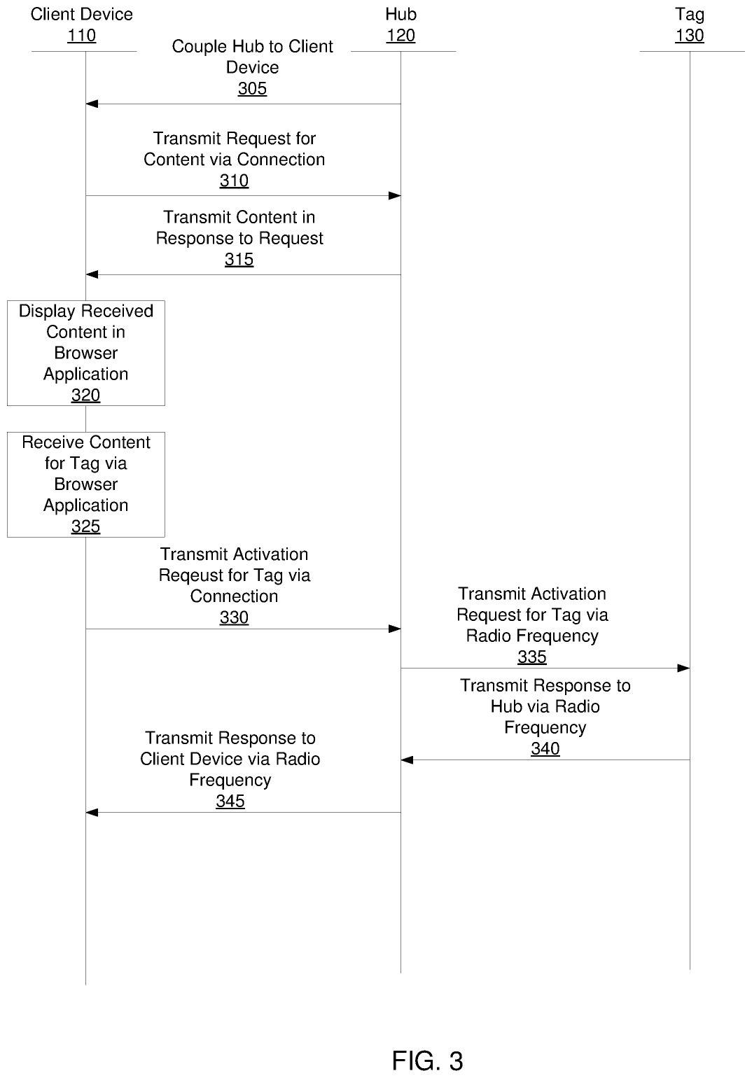

The client device 110 is a computing device capable of receiving user input as well as transmitting or receiving data. In some embodiments, the client device 110 is configured to transmit and to receive data via the network 140. In one embodiment, the client device 110 is a conventional computer system, such as a desktop or a laptop computer. Alternatively, a client device 110 may be a device having computer functionality, such as a personal digital assistant (PDA), a mobile telephone, a smartphone, or another suitable device. The client device 110 is configured to communicate via the network 140. In one embodiment, the client device 110 executes an application allowing a user of the client device 110 to interact with the online system 150 or with other sources of content. For example, the client device 110 executes a browser application to enable interaction between the client device 110 and the online system 150 via the network 140. As further described below in conjunction with FIGS. 2 and 3, by providing a network address of the hub 120 to the browser application, the client device 110 exchanges data with the hub 120 through one or more networking protocols. Example networking protocols for exchanging data between the browser application executing on the client device 110 and the hub 120 include WebSocket, transmission control protocol/Internet protocol (TCP/IP), hypertext transport protocol (HTTP), simple mail transfer protocol (SMTP), and file transfer protocol (FTP).

The hub 120 comprises a computing device coupled to the client device 110 and configured to communicate with one or more tags 130. In various embodiments, the hub 120 is physically connected to the client device 110 via a wired communication channel. For example, the hub 120 is connected to the client device 110 via a Universal Serial Bus (USB) wired connection. In other embodiments, the hub 120 is connected to the client device 110 using any suitable wired connection. Further, the hub 120 may be wirelessly connected to the client device 110 in some embodiments using any suitable wireless communication channel (e.g., BLUETOOTH®, 802.11). In some embodiments, the hub 120 is coupled to the client device 110 using a combination of wired and wireless connections. In some embodiments the hub 120 is coupled to the network 140 using a suitable wired or wireless connection. While FIG. 1 shows an embodiment with the hub 120 and the client device 110 as separate components, in some embodiments, the hub 120 and the client device 110 are combined into a single device including a display device, one or more input devices, a browser application, and a connection to the network 140

Referring to FIG. 2, a block diagram of one embodiment of the hub 120 is shown. In the example shown by FIG. 2, the hub 120 includes a web server 210 and a radio frequency transceiver 220. In other embodiments, the hub 120 may include additional, fewer, or different components than those depicted by FIG. 2.

The web server 210 is embedded in components included in the hub 120, such as one or more hardware components embedded in the hub 120 and configured to execute instructions corresponding to the web server 210, and links the hub 120 to the client device 110 via a direct connection to the client device 110 and links the hub 120 to one or more other systems, such as an online system 150 or a third-party system, via the network 150. The web server 210 serves web pages, as well as other content, such as WebSocket, JAVA®, FLASH®, XML and so forth. In various embodiments, the web server 210 is configured to receive requests from the client device 110 (e.g., via a browser application executing on the client device 110) and to provide content, such as one or more web pages, to the client device 110 via a direct connection or via the network 140. In other embodiments, the web server 210 is configured to send content to the client device 110 (e.g., to a browser application executing on the client device 110) via the direct connection or via the network 140. Additionally, the web server 210 included in the hub 120 is configured to establish a connection with an online system 150, or another source of content, via the network 140. This allows the hub 120 to exchange information with one or more systems via the network 140 and to provide content the hub 120 received from a tag 130 via the network 140 to the client device 110. In various embodiments, the web server 210 includes instructions or logic to request a connection to the online system 150 or other source of content via the network 140, allowing the web server 210 to establish a connection with the online system 150 or with the other source of content that is subsequently used to exchange content between the web server 210 and the online system 140 or the other source of content.

The radio frequency transceiver 220 is configured to emit radio signals in one or more frequency bands and to receive radio signals within one or more frequency bands. The radio frequency transceiver 220 allows the hub to transmit and receive data using various protocols such as Gaussian frequency-shift keying, BLUETOOTH®, ANT®, radio frequency identification (RFID) protocols, near field communication (NFC) protocols, or using any other suitable wireless communication protocol or protocols. While FIG. 2 shows an embodiment of the tag 130 including a radio frequency transceiver 220, in other embodiments, the tag 130 includes a transceiver using any suitable communication channel to exchange data with the hub 120. For example, the tag includes an optical transceiver, such as a free space optical communication transceiver to transmit data to the hub 120 or to receive data from the hub 120 using any suitable wavelength of light or combination of wavelengths of light. In another example, the tag 130 includes an acoustic transceiver configure to exchange data with the hub 120 via acoustic signals. In other embodiments, the tag 130 includes a transceiver configured to transmit or to receive data through any suitable electromagnetic waves allowing wireless exchange of data between the hub 120 and the tag 130.

Referring back to FIG. 1, a tag 130 is a device including a processor, an antenna, and a memory. Additionally, the tag 130 is configured to be coupled to one or more products in some embodiments. The processor executes instructions stored in the memory to modulate or to demodulate radio signals. Additionally, the memory stores information associated with the tag 130, including a tag identifier that uniquely identifies the tag 130. The memory may also include information identifying the one or more objects to which the tag 130 is coupled, which is received via a signal from the hub 120. In some embodiments, the tag 130 includes a power supply and periodically transmits a radio signal including the tag identifier. Alternatively, the tag 130 transmits a radio signal including the tag identifier in response to receiving a request from a radio frequency transmitter, such as the radio frequency transmitter 210 included in the hub 120. In some embodiments, the tag 130 transmits additional information along with the tag identifier 130. For example, the tag 130 transmits information describing one or more products to which the tag 130 is coupled.

In various embodiments, the tag 130 also includes a notification system configured to transmit a notification in response to receiving a notification request from the hub 120. For example, the notification system includes a light source or a display device. Alternatively or additionally, the notification system includes a speaker or another audio device, or a device causing the tag 130 to provide haptic feedback (e.g., to vibrate or to shake). In response to receiving a notification request via the antenna, the notification system is activated. When activated, a light source in the notification system emits light, a display device in the notification system visually displays content (e.g., image, video, or text data), an audio device in the notification request emits sound, or a device causes the tag 130 to shake. A notification request includes a tag identifier, causing activation of the notification system included in a tag 130 having a tag identifier matching the tag identifier included in the signal. Activating the notification system allows the tag 130, along with the one or more products to which the tag 130 is coupled, to be more easily identified.

The tag 130 also includes one or more sensors configured to capture information of an environment surrounding the tag 130, information about a product to which the tag 130 is coupled, or information about the tag 130. For example, a sensor is configured to detect when a package to which the tag 130 is coupled is opened or is closed and to generate an indication when the package is opened or is closed. As another example, a sensor captures information describing vibration or impact of the tag 130. Another example sensor is s position sensor that determines a physical location of the tag 130, such as a global positioning system (GPS) sensor that obtains information, such as latitude and longitude coordinates, identifying the physical location of the tag 130. In other examples, a sensor determines a battery voltage of the tag 130. Other examples of sensors capture information identifying a temperature of an environment surrounding the tag 130, a humidity of the environment surrounding the tag 130, an amount of light in the environment surrounding the tag 130, or any other information describing an environment surrounding the tag 130. As another example, the tag 130 includes a sensor configured to generate an indication 130 in response to tampering with the tag 130. Additionally, the tag 130 may include one or more input devices, such as one or more buttons, a touch screen, one or more switches, or any combination thereof in various embodiments.

When the tag 130 includes one or more sensors, the client device 110 or the online system 150 may transmit a request to the tag 130 identifying one or more sensors, and the tag 130 transmits data captured by the identified one or more sensors to the client device 110 or to the online system 150 in response to the request via the network 140. Additionally, the client device 110 may identify a tag 130, identify one or more sensors, and one or more criteria corresponding to the identified one or more sensors. The identification of the one or more sensors and one or more criteria corresponding to each of the identified sensors are transmitted to the identified tag 130 via the network 140. The tag 130 stores the one or more criteria in association with the corresponding sensor identified in the request. Subsequently, when data captured by a sensor satisfies the one or more criteria associated with the sensor, the tag 130 transmits a notification identifying the tag 130 and the one or more criteria satisfied by data captured by the one or more sensors in a message to the hub 120, which transmits the notification to the client device 110 or to the online system 150. Example criteria include: exceeding a threshold temperature, being less than a threshold temperature, exceeding a threshold humidity, being below a threshold humidity, a battery voltage of the tag 130 being less than a threshold value, a physical location of the tag 130 being outside of specified geographic coordinates, detection of tampering with the tag 130, detection of vibration or impact, or any combination thereof. This allows a user to specify one or more criteria via the client device 110 and the hub 120 that cause the tag to transmit a notification, allowing the tag 130 to transmit a notification when specific conditions satisfying the one or more criteria occur. By customizing criteria for receiving notifications from the tag 130, the client device 110 and the hub 120 allow a user to identify criteria for different tags 130 to transmit notifications, allowing customization of conditions that sensors on individual tags identify.

The client device 110 and the hub 120 are configured to communicate via the network 140, which may comprise any combination of local area and/or wide area networks, using both wired and/or wireless communication systems. In one embodiment, the network 140 uses standard communications technologies and/or protocols. For example, the network 140 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 140 include multiprotocol label switching (MPLS), transmission control protocol/Internet protocol (TCP/IP), WebSocket, hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, all or some of the communication links of the network 140 may be encrypted using any suitable technique or techniques.

The online system 150 coupled to the network 140 for communicating with the client device 110 or with the hub 120. In one embodiment, the online system 150 stores tag identifiers corresponding to different tags 130 and stores information describing a tag 130 in association with a corresponding tag identifier of the tag 130. For example, the online system 150 stores information received from the client device 110 identifying one or more products to which a tag 130 is coupled in conjunction with a tag identifier for the tag 130, an address corresponding to the tag 130, a user associated with the tag 130, or any other suitable information associated with the tag 130. The online system 150 may communicate information associated with a tag 130 to the client device 110 for display in response to receiving a request including the tag identifier corresponding to the tag 130 via the network 140.

### Configuring a Tag Via a Hub Coupled to a Client Device

FIG. 3 is an interaction diagram of one embodiment of a method for configuring a tag 130 via a hub 120 coupled to a client device 110. In various embodiments, the method includes different or additional steps than those described in conjunction with FIG. 3. Additionally, in some embodiments, the method performs steps in a different order than the order described in conjunction with FIG. 3.

The hub 120 is coupled 305 to the client device 110 via a direct connection capable of exchanging data through one or more networking protocols. Example networking protocols for exchanging data between the client device 110 and the hub 120 include WebSocket, transmission control protocol/Internet protocol (TCP/IP), hypertext transport protocol (HTTP), and file transfer protocol (FTP). In various embodiments, the hub 120 is coupled 305 to the client device 110 via a wired connection. For example, the hub 120 is coupled 305 to the client device 110 via a Universal Serial Bus (USB) cable. In another example, the hub 120 is coupled to the client device 110 via an Ethernet cable. Alternatively, the hub 120 is coupled 305 to the client device 110 via a wireless connection capable of exchanging data using one or more networking protocols. Example wireless networking protocols include 802.11, worldwide interoperability for microwave access (WiMAX), 3G, 4G, 5G, code division multiple access (CDMA), and Long Term Evolution (LTE). Alternatively, the hub 120 is coupled 305 to the online system 150 via the network 140.

A browser application executing on the client device 110 receives a identifier of the hub 120 and transmits 310 a request for content to the hub 120 via the connection between the hub 120 and the client device 110, or via the online system 150. For example, a user of the client device 110 specifies a network address or an Internet Protocol (IP) address of the hub to the browser application, which transmits 310 the request for content to the hub 120 via the connection between the client device 110 and the hub 120, or via the connection between the client device 110 and the online system 150 and the connection between the online system 150 and the hub 120. In response to receiving the request, the hub 120 transmits 315 content to the client device 110 via the connection between the client device 110 and the hub 120, or via the between the hub 120 and the online system 150 and via the connection between online system 150 and the client device 110. As further described above in conjunction with FIG. 2, the hub 120 includes a web server embedded into the hub 120 that is configured to transmit content, such as web pages, to a client device 110 coupled to the hub 120. In some embodiments, the web server is hardware configured to provide the web server functionality and embedded in the hub 120. The connection between the client device 110 and the hub 120 supports transmission of data via a WebSocket protocol or any other networking protocol allowing bidirectional communication of content or other data between the client device 110 and the hub 120.

The client device 110 displays 320 the content from the hub 120 via the browser application executing on the client device 110. For example, the browser application displays 320 one or more web pages or content received from the hub or received from the online system 150. Through the web pages or content obtained from the hub 120 or from the online system 150 and displayed on the client device 110, a user of the client device 110 enters information for configuring a tag 130 that is received 325 by the client device 110. In some embodiments, the tag 130 is positioned proximate to the hub 120, which obtains a tag identifier identifying the tag 130 via the radio frequency transceiver 220 included in the tag 130. For example, the radio frequency transceiver 220 in the tag 130 is a near field communication transceiver, so the hub obtains the tag identifier of the tag 130 when the tag 130 is within a threshold distance of the hub 120. The hub 120 communicates the tag identifier from the tag 130 to the client device 110 via the connection. As further described above in conjunction with FIG. 1, the tag 130 modulates and demodulates radio signal and includes an antenna for receiving or for transmitting one or more radio signals. Additionally, the tag 130 is configured to be coupled to one or more products in some embodiments.

Information received 325 by the client device 110 for configuring a tag 130 includes a tag identifier that uniquely identifies the tag 130. Other information may be received 325, such as information identifying the one or more objects to which the tag 130 is coupled, an address associated with the tag 130, information identifying a user associated with the tag 130, or any other suitable information. The client device 110 may receive multiple web pages for the hub 120, with different web pages configured to receive 325 different information for the tag 130. In other embodiments, the client device 110 includes a single web page from the hub 120 that includes multiple fields for receiving 325 different information for configuring the tag 130.

The client device 110 transmits the content for the tag 130 to an online system 150, which maintains the content associated with the tag. In various embodiments, the online system 150 maintains data associating content with a tag identifier corresponding to the tag 130. Example content associated with the tag identifier includes one or more products to which the tag 130 is coupled 130, a user associated with the tag 130, or any other suitable information. For example, the online system 150 maintains a database of information associated with tags 130 received from the client device 110 (or from additional client devices 110) or from the hub 120, and the client device 110 retrieves content associated with one or more tags 120 from the online system 150 or transmits content for association with one or more tags 120 to the online system 150 via the network In various embodiments, the client device 110 transmits the content for the tag 130 to the online system 150 via a different connection than the connection between the hub 120 and the client device 110. For example, the client device 110 establishes a connection to a network 140 and transmits the content for the tag 130 to the online system 150 via the network 140. In some embodiments, the client device 110 may transmit the content for the tag 130 to the hub 120, which subsequently transmits the content for the tag 120 to the online system 150 via a connection between the hub 120 and the network 140. In some embodiments, the client device 110 may transmit the content for the tag to the online system 150, which subsequently transmits the content for the tag 130 to the hub 120 via a connection between the hub 120 and the network 140.

Via the browser application executing on the client device 110, the tag 130 may be activated by the browser application communicating with the hub 120 via the connection between the client device 110 and the hub 120. To activate the tag 130, the browser application receives an activation request for the tag 130 and transmits 330 the activation request to the hub 120 via the connection between the client device 110 and the hub 120. The activation request includes a tag identifier that uniquely identifies the tag 130. Additionally, the activation request may identify one or more sensors included in the tag 130 and one or more criteria corresponding to the identified one or more tags 130. As further described above in conjunction with FIG. 1, the one or more criteria corresponding to an identified sensor specify that the tag 130 transmit a notification or other content to the client device 110, or to the online system 150, when data captured by the identified sensor satisfy the one or more criteria. Via a radio frequency transmitter, the hub 120 transmits 335 the activation request via a radio signal. A different connection than the connection between the client device 110 and the hub 120 is used by the hub 120 to transmit 335 the activation request to the tag 130. For example, the connection between the hub 120 and the client device 110 is a WebSocket connection through a USB cable, while the hub 120 transmits 335 the notification request to the tag 130 via a radio frequency wireless channel, such as a Near Field Communication (NFC) wireless channel. Hence, the direct connection between the client device 110 and the hub 120 allows a user of the client device 110 to transmit an activation request to the tag 130 through a browser application executing on the client device 110 without installing or configuring a specialized application on the client device 110 to communicate with the tag 130, but by leveraging the embedded hardware in the hub 120 comprising the web server. This simplifies activation of the tag 130 by allowing the client device 110 to leverage an existing application executing on the client device 110 to communicate with the hub 120, which transmits 335 the activation request for activating the tag 130 received via the browser application executing on the client device 110 to the tag 130 through the web server embedded in the hub 120.

When the tag 130 receives the activation request, the tag 130 extracts the tag identifier from the activation request and compares the tag identifier in the activation request to a tag identifier stored by the tag 130. In response to the tag identifier included in the activation request matching the tag identifier stored in the tag 130, the tag 130 transmits 340 a response, which may include content for the client device 110. The tag 130 transmits 340 the response to the hub 120 via radio frequency, and the hub 120 transmits 345 the response to the client device 110 via the connection between the hub 120 and the client device 120. If the activation request requests information from one or more sensors, the response from the tag 130 includes data captured by one or more of the sensors included in the tag 130 identified by the activation request. In other embodiments, the activation request identifies one or more sensors and one or more criteria corresponding to the identified one or more sensors, and the tag 130 stores the criteria from the activation request in association with the corresponding one or more sensors. Subsequently, the tag 130 transmits 340 the response when data captured by an identified sensor included in the tag 130 captures data satisfying one or more of the criteria corresponding to the identified sensor. The response may include any suitable content, such as data captured by one or more sensors included in the tag 130, an identification of the one or more criteria satisfied by data captured by the one or more sensors, or any other suitable content.

As further described above in conjunction with FIG. 1, the tag 130 may include a notification system that emits light or that emits an audio signal. The activation request may activate the notification system of the tag 130 to simplify locating the tag 130. The notification provided by the notification of the tag 130 may be audio feedback, visual feedback, haptic feedback, or any combination thereof.

In some embodiments, different tags 130 are associated with different users who each have a client device 110. The hub 120 or the online system 150 maintains associations between different users and tags 130 corresponding to each of the different users. When a user transmits an activation request from the user's corresponding client device 110 to the hub 120, the hub 120 transmits the activation request 120 to the tag 130 corresponding to the user, causing the notification system of the tag 130 to provide feedback. For example, the tag 130 corresponding to the user provides audio feedback, visual feedback, or haptic feedback in response to receiving the activation request from the user corresponding to the tag 130. If the tag includes a display device in the notification system, the display device may display information identifying the user in response to receiving the activation request from the user corresponding to the tag 130. In some embodiments, the hub 120 includes a display device and displays information identifying the user via the display device included in the hub 120; this allows information identifying the user from whom the activation request was received via the hub 120.

Additionally, the client 110 or the hub 120 may transmit the activation request to the online system 150 via a network 140, where the online system 150 transmits the notification request to one or more additional hubs 120. The 120 hub transmits a request to establish a connection to the online system 150 via the network 140. The online system 150 responds to the request by establishing a connection with the hub 120 via the network 140, allowing the hub 120 and the online system 150 to exchange data via the network 140. Hence, the web server included in the hub 120 may be used to initiate a connection via the network 140 with the online system 150, which establishes a connection for exchanging data with the hub 140 in response to receiving the request.

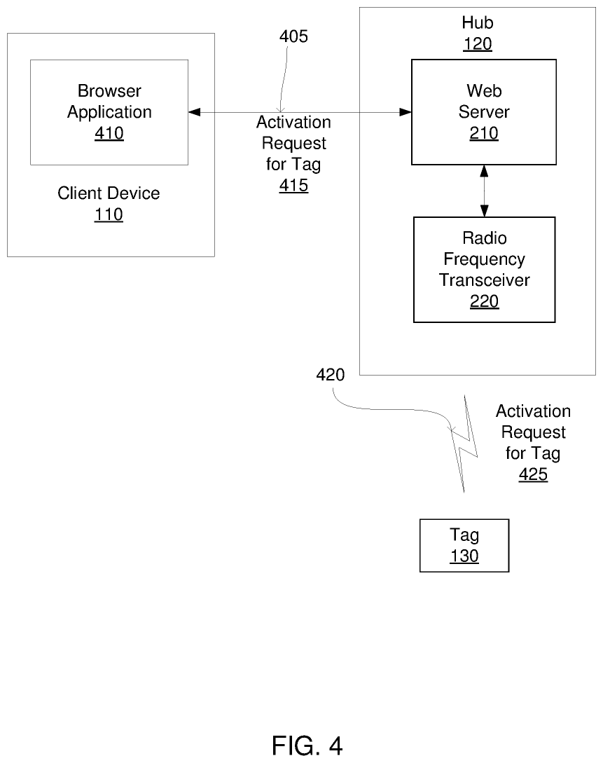

FIG. 4 is a process flow diagram of one embodiment of a client device 110 communicating with a tag 130 via a hub 120 coupled to the client device 110. As further described above in conjunction with FIG. 3, the hub 120 is coupled to a client device 110 via a connection 405 capable of exchanging data through one or more networking protocols. For example, the connection 405 is a connection exchanging data between the client device 110 and the hub 120 using a WebSocket protocol. In various embodiments, the connection 405 is a wired connection, such as Universal Serial Bus (USB) cable coupled to the client device 110 and to the hub 120. In other embodiments, the connection 405 is a wired or wireless connection between the client device 110 and the network 140, and between the network 140 and the hub 120. The client device 110 initially establishes the connection 405 by transmitting a request to a web server 210 included in the hub 120 from a browser application 410 executing on the client device 110. In response to the web server 210 receiving the request, the web server 210 transmits one or more web pages or content to the browser application 140 for display via the connection 405. Hence, the client device 110 establishes the connections 405 and exchanges content with the hub 120 using the browser application 405 rather than through a specialized application installed on the client device 110 for communicating with the hub 120. This allows the client device 110 and the hub 120 to communicate with each other without installation of specific software on the client device 110, simplifying communication between the hub 120 and the client device 110.

When the client device 110 transmits an activation request 415 for a tag 130 to the hub 120 via the connection 405 between the hub 120 and the client device 110, the web server 210 of the hub 120 communicates a notification request 425 corresponding to the received activation request 415 for the tag 130 to a radio frequency transceiver 220 of the hub 120. Using a radio frequency communication channel 420 that is different from the connection 405 between the hub 120 and the client device 110, the radio frequency transceiver 220 transmits the notification request 425 for the tag 130 to the tag 130. For example, the radio frequency communication channel 420 is a Near Field Communication (NFC) communication channel. For example, the notification request includes a tag identifier uniquely identifying the tag 130, and the radio frequency transceiver 220 of the hub 120 transmits the notification request 425 including the tag identifier using the radio frequency communication channel 420. Hence, the browser application 405 executing on the client device 110 leverages the connection 405 between the client device 110 and the hub 120 to locate the tag 130 using the radio frequency transceiver 220 of the hub.

When a tag 130 having a tag identifier matching the tag identifier included in the request receives the activation request 425 for the tag 130, a notification system included in the tag 130 transmits a notification. For example, in response to the tag 130 with a tag identifier matching the tag identifier included in the activation request 425 receiving the activation request 425, the notification system of the tag 130 emits light, emits an audio signal, vibrates the tag 130, or performs any suitable actions or actions to identify the tag 130. In other embodiments, the activation request 425 includes one or more criteria that, when satisfied by data captured by one or more sensors in the tag 130, cause the tag 130 to transmit data to the hub 120 via the ratio frequency communication channel 420 (e.g., an indication that one or more of the criteria have been satisfied by data captured by one or more sensors in the tag 130). In some embodiments, the tag 130 transmits an indication to the hub 120 via the radio frequency communication channel 420 that the notification system of the tag 130 is emitting a notification. The web server 210 may transmit the indication that the tag is emitting a notification to the browser application 405 executing on the client device 110 via one or more web pages transmitted via the connection 405 between the client device 110 and the hub 120.

### Additional Configuration Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a hub configured to be coupled to a client device, the hub including a web server embedded in the hub, the web server configured to be accessed by a browser executing on the client device via a connection between the client device and the hub, and the hub including a radio frequency transceiver; and
a tag having a tag identifier uniquely identifying the tag and including a notification system, the tag configured to receive an activation request from the radio frequency transceiver included in the hub, the activation request received by the hub from the browser executing on the client device, the notification system configured to transmit a notification in response to the tag identifier of the tag matching a tag identifier included in the activation request.

2. The system of claim 1, wherein the notification system comprises an illumination source configured to emit light in response to the tag receiving the notification request.

3. The system of claim 1, wherein the notification system comprises an audio source configured to emit an audio signal in response to the tag receiving the notification request.

4. The system of claim 1 wherein the tag is configured to be coupled to one or more products.

5. The system of claim 1, further comprising:
an online system communicatively coupled to the hub via a network, the online system configured to establish a communication channel with the hub via the network in response to receiving a request from the hub.

6. The system of claim 5, wherein the online system is further configured to transmit data received from the hub to another hub at a different location via the network.

7. The system of claim 5, wherein the online system is further configured to transmit data received from the client device to one or more additional hubs via the network.

8. The system of claim 5, wherein the online system is configured to exchange content with one or more client devices via the network.

9. The system of claim 5, wherein a connection between the hub and the online system communicates data via WebSocket.

10. The system of claim 5, wherein the online system is configured to receive the tag identifier of the tag and content associated with the tag.

11. The system of claim 10, wherein the content associated with the tag identifies one or more objects to which the tag is coupled.

12. The system of claim 11, wherein the content associated with the tag further includes information describing a user associated with the tag.

13. The system of claim 1, wherein the tag includes one or more sensors.

14. The system of claim 13, wherein a sensor is selected from a group consisting of: a sensor configured to detect when a package to which the tag is coupled is opened, a sensor configured to capture vibration or impact of the tag, a position sensor configured to determine a physical location of the tag, a sensor configured to determine a battery voltage of the tag, a sensor configured to capture information identifying a temperature of an environment surrounding the tag, a sensor configured to capture information identifying a humidity of the environment surrounding the tag, a sensor configured to capture information identifying an amount of light in the environment surrounding the tag, a sensor configured to determine whether the tag has been tampered with, and any combination thereof.

15. The system of claim 12, wherein the tag is configured to transmit content based on the one or more sensors to the hub via radio frequency, the hub configured to transmit the content to the client device.

16. The system of claim 1, wherein the connection between the hub and the client device communicates data via WebSocket.

17. The system of claim 1, wherein the radio frequency communication channel comprises a Near Field Communication (NFC) communication channel.

18. The system of claim 1, wherein the tag is associated with a user.

19. A method comprising:
establishing a connection between a hub and a client device, the connection configured to exchange data using one or more networking protocols and a web server embedded in the hub;
receiving an activation request at the web server included in the hub from a browser application executing on the client device via the connection between the hub and the client device, the activation request including a tag identifier uniquely identifying a tag;
transmitting an activation request including the tag identifier from the hub via a radio frequency communication channel to one or more tags, the activation request causing a notification system included in a tag having a tag identifier matching the tag identifier included in the activation request to transmit a notification.

20. The method of claim 19, wherein a networking protocol of the one or more networking protocols comprises WebSocket.

21. The method of claim 19, wherein the radio frequency communication channel comprises a Near Field Communication channel.

22. The method of claim 19, wherein the connection between the client device and the hub comprises a wired connection.

23. The method of claim 22, wherein the wired connection comprises a Universal Serial Bus connection.

24. The method of claim 19, wherein the connection between the client device and the hub is via a network.
